(19) United States
(12) Patent Application Publication
(10) Pub. No.: US 2007/0223536 A1
(43) Pub. Date: Sep. 27, 2007

(54) Stream reproducing method and device

(75) Inventor: Michihiro Fukushima, Fuchu-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Toshiba America Information Systems, Inc.

(21) Appl. No.: 11/644,465

(22) Filed: Dec. 21, 2006

(30) Foreign Application Priority Data
Mar. 24, 2006 (JP) 2006-083926

(51) Int. Cl. H04J 3/06

(52) U.S. Cl. 370/503; 370/389

(57) ABSTRACT

According to one embodiment, a stream reproducing method comprises a rewriting and decoding operation. First, a time stamp value added to transport stream (TS) packet in a time stamped transport stream is rewritten. The rewritten time stamp value now is synchronous with a program clock reference (PCR) value. Next, the TS packet is output in a synchronous time stamped transport stream based on a comparison between count values produced by a first counter counting clocks generated by a clock oscillator and the rewritten time stamp value of the TS packet in the synchronous time stamped transport stream. Thereafter, the TS packet is decoded according to a count in a second counter counting the clocks generated by the clock oscillator.

### CROSS-REFERENCE TO RELATED APPLICATIONS

This application is based upon and claims the benefit of priority from Japanese Patent Application No. 2006-083926, filed Mar. 24, 2006, the entire contents of which are incorporated herein by reference.

### BACKGROUND

1. Field

One embodiment of the invention relates to a stream reproducing method and device for reproducing data streams obtained through digital broadcasting.

2. Description of the Related Art

In recent years, Communication Satellite (CS)- or Broadcasting Satellite (BS)-based digital broadcasting and terrestrial digital broadcasting have become popularized. These digital broadcasting allows vivid pictures to be viewed on large screens in common homes.

One method of decoding a transport stream (TS) obtained by receiving a digital broadcast or recording it on a recording medium, such as a hard disk (HD), involves attaching time stamps, produced by the receiver on the basis of its uniquely generated clock signal, to TS packets in the TS. The time stamp attached TS is referred to as the time stamped transport stream (TTS). The TS packets forming the TS include one or more PCR packets containing a program clock reference (PCR) (time information) every 100 milliseconds.

In Japanese Patent Application KOKAI Publication No. 2003-283996 is disclosed a time stamp attaching device which, upon reception of a TS, attaches time stamps synchronized with PCR time information to TS packets to produce a TTS.

In reproducing a usual TTS in which time stamps are not synchronized with PCR, the TTS has time stamps in the TS packets removed at times corresponding to the time stamps and then output to a decoder as the TS. In this case, each TS packet is output to the decoder in accordance with a value in a counter operated by a time-stamp clock signal uniquely generated by the reproducing device. For example, when a coincidence occurs between a value in the counter and the value of a time stamp, the corresponding TS packet is output to the decoder.

In decoding, the PCR contained in the PCR packets is extracted and a clock signal (system time clock: STC) is then generated which is synchronized with the PCR. The clock signal STC is generated through the use of a voltage-controlled oscillator such as a voltage-controlled xtal oscillator (VCXO). In the decoder, decoding is carried out on the basis of the clock signal STC. Therefore, the clock signal STC is a clock signal of a different system from the clock signal for time stamps and both the clock signals are not synchronized with each other.

Thus, reproducing a TTS in which the time stamps and the PCR are not synchronized requires two clock systems: one for time stamps and one for PCR.

### BRIEF DESCRIPTION OF THE SEVERAL VIEWS OF THE DRAWINGS

The drawings and the associated descriptions are provided to illustrate embodiments of the invention and not to limit the scope of the invention.

FIG. 1 is a schematic block diagram of a stream reproducing device according to a first embodiment of the present invention;

FIG. 2 shows an exemplary embodiment of the TTS format;

FIG. 3 shows an exemplary embodiment of the TS header format;

FIG. 4 shows an exemplary embodiment of the PES format;

FIG. 5 is a graph illustrating a first embodiment of an operation of the time stamp rewriting section shown in FIG. 1;

FIG. 6 is a graph illustrating a second embodiment of an operation of the time stamp rewriting section shown in FIG. 1; and

FIG. 7 is a schematic block diagram of a stream reproducing device according to a second embodiment of the present invention.

### DETAILED DESCRIPTION

Various embodiments according to the invention will now be described hereinafter. In general, according to one embodiment of the invention, there is provided a stream reproducing method comprising: temporarily recording a time stamped transport stream (TTS) read from a recording medium in a data buffer, the time stamped transport stream being such that each of transport stream (TS) packets forming the TTS has been added with a time stamp, some of the TS packets each contain a program clock reference (PCR), and the time stamp and PCR values are asynchronous with each other due to different clock systems; detecting the PCR in the TTS supplied from the data buffer; rewriting the time stamp value added to each of the TS packets in the TTS from the data buffer to a value synchronous with the detected PCR value to provide a synchronous TTS; outputting each TS packet in the synchronized TTS on the basis of comparison between the count in a first counter counting clocks generated by a clock oscillator and the time stamp value of the corresponding TS packet in the synchronous TTS; and decoding the output TS packet according to the count in a second counter counting the clocks generated by the clock oscillator.

This embodiment of the invention allows a TTS in which the time stamps are not synchronized with the PCR to be reproduced using one clock system.

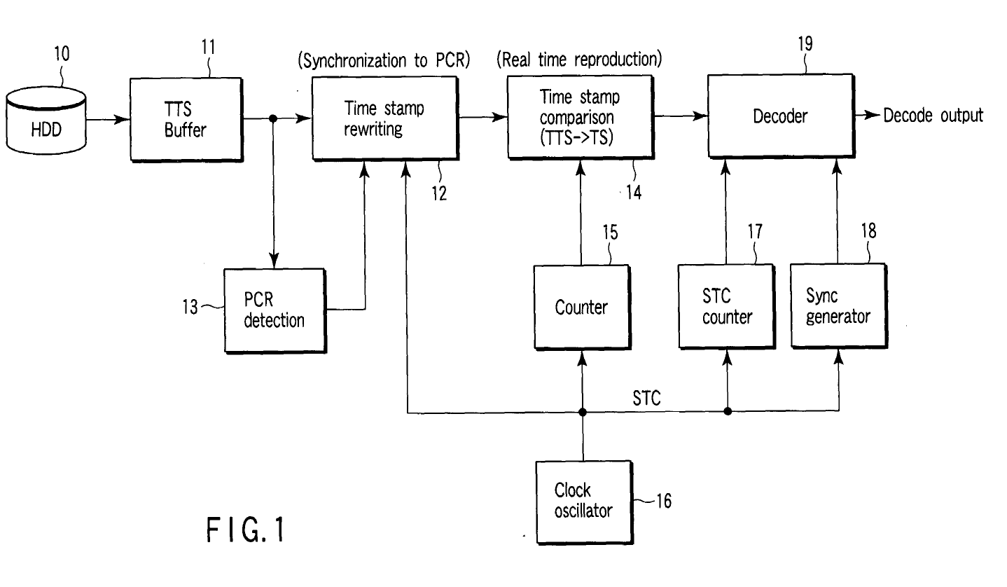

FIG. 1 is a schematic block diagram of a stream reproducing device according to a first embodiment of the present invention. This stream reproducing device is applied to a video reproducing device, such as a TV set or DVD recorder, which is adapted to receive and reproduce a digital broadcast.

A TS obtained by receiving a digital broadcast is time stamped for each TS packet and then recorded as a TTS on an information recording medium, such as a hard disk on a hard disk drive (HDD) 10. The TTS is recorded with the time stamp values attached to TS packets and the PCR values varied asynchronously from each other on the basis of different clock systems (clock signals of different frequencies).

The TTS is applied from the HDD 10 through a TTS buffer 11 to a time stamp rewriting section 12 of one embodiment of the invention. At this point, the PCR in the TTS is detected by a PCR detector 13 and then applied to the time stamp rewriting section 12. The TTS buffer 11 is used to absorb the difference in processing speed between the HDD 10 on the input side and the time stamp rewriting section 12 on the output side.

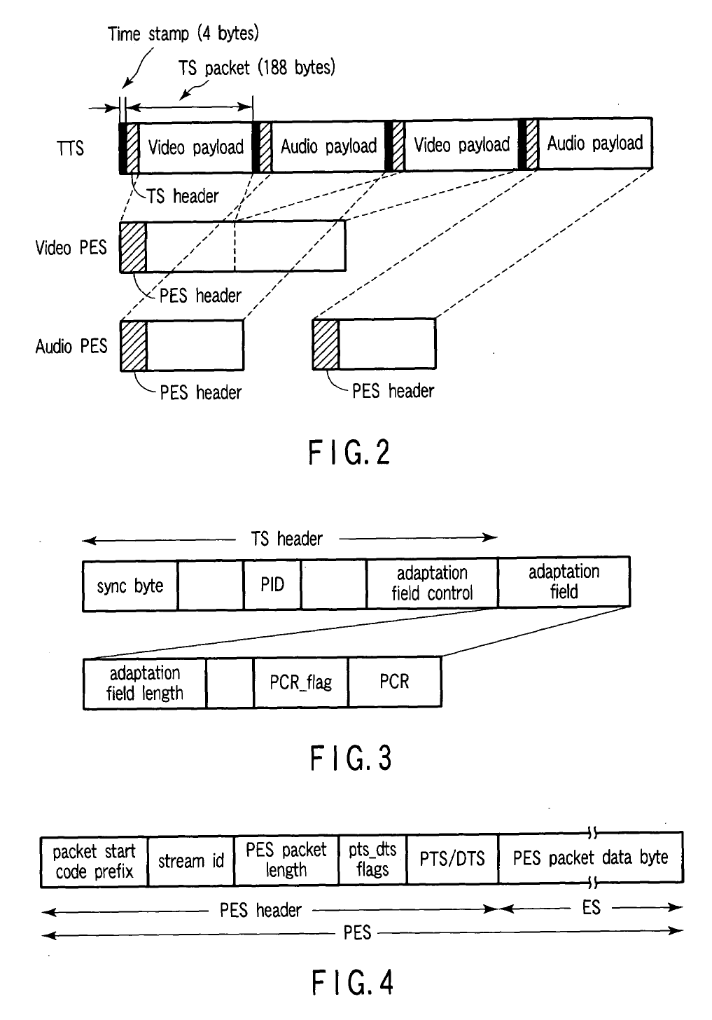

An explanation of the TTS will be given here. FIG. 2 shows an exemplary embodiment of the format of the TTS. The TTS is formed by adding a time stamp of four bytes to each of the TS packets of 188 bytes which make up a TS. The time stamp, which is added to each TS packet in the TTS by a receiver to which the invention is applied when it is received through digital broadcasting, indicates the receive timing of the corresponding TS packet.

Each TS packet is comprised of a TS header and a payload. The payload, which is an MPEG-2 coded stream by way of example, contains a divided video or audio PES.

FIG. 3 shows an exemplary embodiment of the format of the TS header. Sync byte is a code (0x47) indicating the beginning of a corresponding TS packet. “PID” is called packet ID. Each of the video PES and the audio PES has a uniquely determined different PID value. The examination of PID allows which of video PES and audio PES a corresponding TS packet contains to be recognized. “Adaptation field control” is a flag which indicates the presence or absence of an adaptation field and a payload in the corresponding packet.

As further shown, the Adaptation field comprises an Adaptation field length and a PCR_flag. The “Adaptation field length” contains a value indicating the length of the adaptation field. “PCR flag” is a flag which indicates the presence or absence of a PCR, which is time information given when the corresponding TS is produced and is usually used to calibrate the time of the receiver. A TS packet containing a PCR is referred to as a PCR packet. One PCR packet is contained in a TS every 100 ms, for example. In terms of video frames, one PCR packet is contained in the TS corresponding to three frames, for example.

FIG. 4 shows an exemplary embodiment of the format of the PES. The video PES and the audio PES are identical in format. The PES is comprised of a header portion called a PES header and PES packet data bytes, i.e., an elementary stream (ES). The ES is video or audio data coded with compression in itself. Packet start code prefix contained in the PES header is a code (0x000001) indicating the beginning of the PES. Stream id is a value indicating the type of the stream. PES packet length is a value indicating the length of the PES. DTS (decoding time stamp) is time information indicating the time at which the PES is to be decoded. PTS (presentation time stamp) is time information indicating the time at which the decoded data is to be output. Video and audio can be synchronized by outputting each of them from the decoder 19 at the time indicated by the PTS.

Returning to FIG. 1, the time stamp rewriting section 12 rewrites the values of time stamps in an input TTS so that they become synchronized with or equal to the PCR in the TS. This allows the time stamp and the PCR to be handled with the same clock system (clock oscillator). This operation will be described later. Here, that the time stamp is synchronized with the PCR means that the time stamp value and the PCR value increase at the same rate or similar rate.

The TTS, which has time stamps rewritten by the time stamp rewriting section 12, is applied to the time stamp comparator 14. The counter 15 counts clocks generated by the clock oscillator 16.

At the time when the value of the time stamp attached to a TS packet in the input TTS becomes coincident with the count in the counter 15, the time stamp comparator 14 outputs that TS packet. In this way, the time stamp comparator 14 outputs the TS packets in real time.

The STC counter 17 counts clock cycles of STC generated by the clock oscillator 16. The decoder 19 decodes video and audio MPEG coded streams in the ES on the basis of the PTS/DTS (see FIG. 4) contained in the PES headers in the payload portions of TS packets and the count in the STC counter 17. For example, at the occurrence of a coincidence between the DTS value in the PES header of a TS packet and the count in the STC counter, the decoder decodes a data stream in the ES of that TS packet. The sync generator 18 generates vertical sync signals and horizontal sync signals.

As described above, the time stamp is time information which is attached to each TS packet upon reception of a digital broadcast and the PCR is time information which is attached to the TS on the transmission side. That is, the time stamp and the PCR are asynchronous time information produced by clock signals of different frequencies. To reproduce video and audio from such a TTS, it is conventionally required to use two clock oscillators: one for time stamp used in outputting TS packets from a TTS in real time (the processing by the time stamp comparator 14) and one for PCR used in PCR synchronized clock (STC)-based decode processing.

According to one embodiment of the invention, the time stamps in an input TTS are rewritten to values synchronized with the PCR in the TTS by the time stamp rewriting section 12. Therefore, the same clock system can be used for the clock to drive the comparison counter 15 that provides comparands to the time stamp compare output section 14 and the clock to drive the STC counter used in the decode processing by the decoder 19. That is, clocks produced based on the clock generated by the clock oscillator 16 can be used in the compare processing and the decode processing.

The time stamp rewriting section 12, the PCR detecting section 13, the time stamp compare output section 14, the counter 15, the decoder 19, the STC counter 17, and the sync generator 18 may be implemented in hardware or in software.

FIG. 5 is a graph illustrating a first embodiment of an operation of the time stamp rewriting section 12.

At a time when the PCR detecting section 13 detects PCR in a TTS from the TTS buffer 11 (for example, at time td), the time stamp rewriting section 12 detects the difference Δ, between the PCR value and the time stamp value of the TS packet containing the detected PCR. The time stamp rewriting section 12 then subtracts the difference Δ from each of the time stamp values of TS packets, from the TS packet containing the detected PCR through the TS packet TMSp immediately before PCR to be detected next. In this way, all the time stamp values are rewritten.

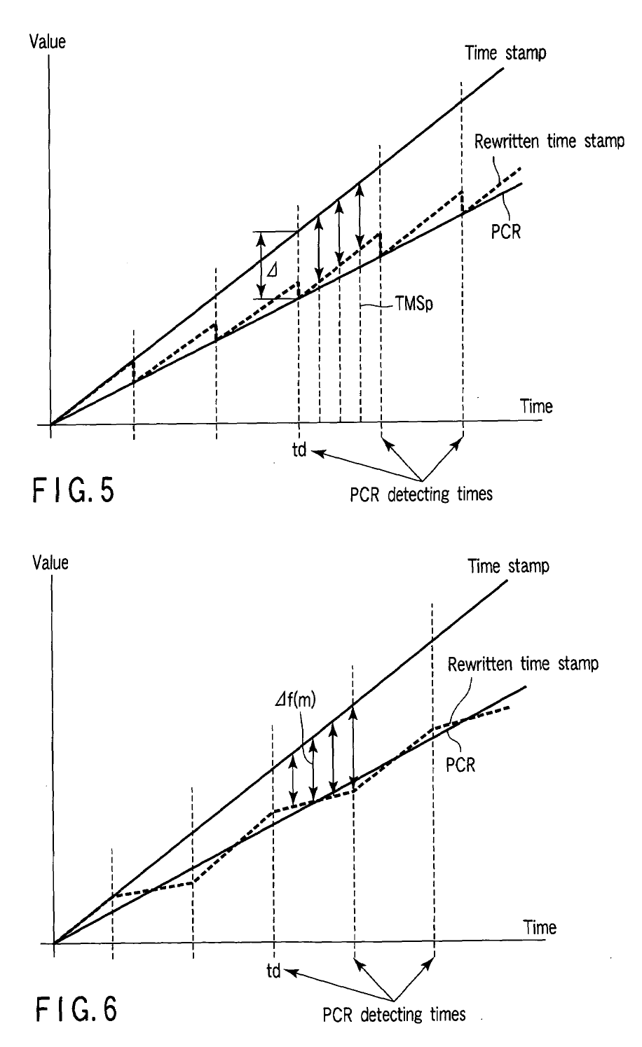

FIG. 6 is a graph illustrating a second operation of the time stamp rewriting section 12.

Unlike the first embodiment of the operation in which the difference Δ is simply subtracted from the time stamp values, in this second embodiment of the operation, after PCR has been detected (for example, after time td), the time stamp value of the m-th TS packet is corrected using a correction value Δf(m) that varies according to m.

This approach is effective in preventing the corrected time stamp value at the time a TS packet containing PCR is output from becoming greatly different from the corrected time stamp value at the time the preceding TS packet is output when the frequency difference between the time stamp and PCR clock systems is great.

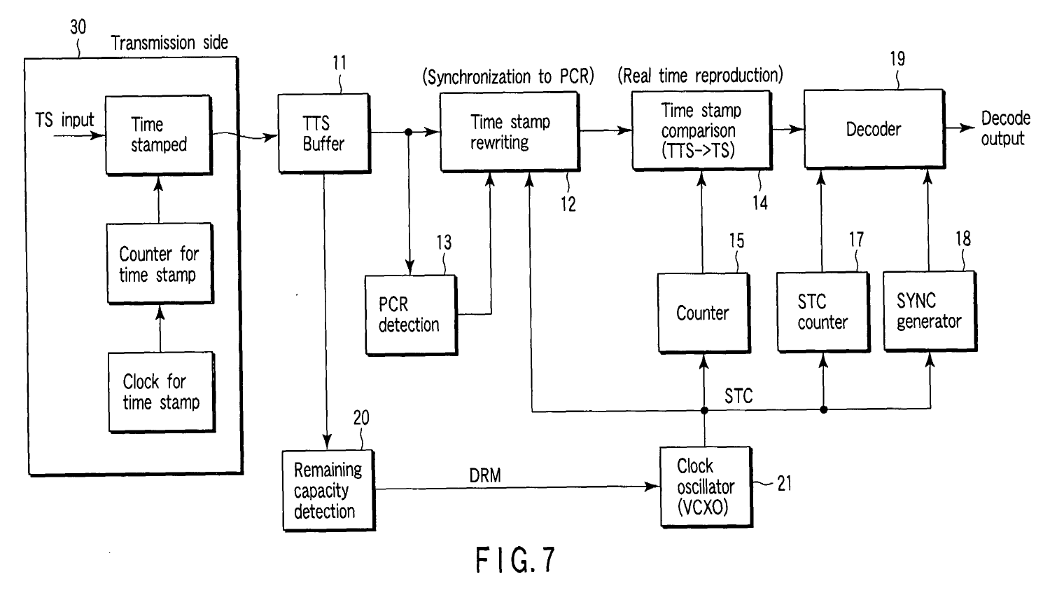

FIG. 7 is a schematic block diagram of a stream reproducing device according to a second embodiment of the present invention.

The second embodiment differs from the first embodiment shown in FIG. 1 in that a remaining capacity detecting section 20 is provided which detects the remaining capacity of the TTS buffer and a voltage controlled xtal oscillator (VCXO) 21 is used in place of the self-running clock oscillator 16.

From a transmission-side device 30 a TTS is transmitted in real time and input to the TTS buffer 11. The TTS buffer is used to absorb the jitter of an input signal. The remaining capacity detecting section 20 detects the remaining capacity (free capacity) of the TTS buffer 11 and outputs a signal indicating the detected remaining capacity to the clock oscillator (VCXO) 21. The clock oscillator 21 has its oscillation frequency controlled according to the detect signal DRAM from the remaining capacity detecting section 20. For example, the oscillation frequency decreases when the remaining capacity shows a tendency to increase and vice versa. Thus, by observing changes in the remaining capacity of the TTS buffer 11 over a long period of time, the oscillation frequency of the clock oscillator (VCXO) 21 is controlled so that the buffer will not underflow or overflow.

According to the present invention, as described above, the time stamps in an input TTS are rewritten to be synchronized to the PCR clock system, which allows the input TTS to be decoded using a single clock system.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method comprising:
rewriting a time stamp value added to transport stream (TS) packet in a time stamped transport stream, the rewritten time stamp value being synchronous with a program clock reference (PCR) value;
outputting the TS packet in a synchronous time stamped transport stream based on a comparison between count values produced by a first counter counting clocks generated by a clock oscillator and the rewritten time stamp value of the TS packet in the synchronous time stamped transport stream; and
decoding the TS packet according to a count in a second counter counting the clocks generated by the clock oscillator.

2. The method according to claim 1, wherein the clock oscillator is a fixed clock oscillator.

3. The method according to claim 1, wherein prior to rewriting the time stamp value, the method further comprising:
temporarily recording the time stamped transport stream in a data buffer, the time stamped transport stream including a plurality of TS packets, one of the plurality of TS packets including the time stamp value and the PCR value that is asynchronous with the time stamp value.

4. The method according to claim 3, wherein the time stamped transport stream is read from a recording medium.

5. The method according to claim 3, wherein prior to rewriting the time stamp value, the method further comprising:
detecting the PCR value in the time stamped transport stream supplied from the data buffer.

6. The method according to claim 1, wherein the rewriting of the time stamp value includes (1) detecting a difference between the PCR value and the time stamp value and (2) rewriting the time stamp value of the TS packet by using the difference.

7. The method according to claim 1, wherein each TS packet includes a header and a payload, the payload including video.

8. The method according to claim 1, wherein the header of the TS packet includes a code indicating a beginning of the TS packet, a packet identifier to uniquely identify the video, and a flag set to identify that the TS packet includes the PCR value.

9. A method comprising:
detecting program clock reference (PCR) values in a time stamped transport stream, the time stamped transport stream including a plurality of transport stream (TS) packets each including a time stamped value and a corresponding PCR value;
rewriting each time stamp value added to each TS packet in the time stamped transport stream to a value synchronous with the corresponding PCR value;
outputting the plurality of TS packets in the synchronous time stamped transport stream based on a comparison between a count in a first counter counting clocks generated by a clock oscillator and the rewritten time stamp value of the TS packet in the synchronous time stamped transport stream; and
decoding the output TS packets according to a count in a second counter counting the clocks generated by the clock oscillator.

10. The method of claim 9, wherein prior to detecting the PCR values, the method further comprising:
temporarily storing the time stamped transport stream in a data buffer.

11. The method of claim 10, wherein prior to rewriting one or more time stamp values, the method further comprising:
detecting a remaining capacity of the data buffer; and
causing the clock oscillator to vary its oscillation frequency according to the remaining capacity of the data buffer.

12. A stream reproducing device comprising:
a rewriting section to rewrite a time stamp value within a time stamped packet partially forming a time stamped transport stream so that the time stamp value is synchronous with a detected program clock reference (PCR) value in order to produce a synchronous time stamped transport stream;
a clock oscillator;
a first counter to count clocks generated by the clock oscillator;
a comparator to compare the count in the first counter with the rewritten time stamp value of the time stamped packet in the synchronous time stamped transport stream received from the rewriting section;
a second counter to count clocks generated by the clock oscillator; and
a decoder to decode the time stamped packet output from the comparator according to the count in the second counter.

13. The stream reproducing device of claim 12, wherein the time stamp value and the PCR value are initially asynchronous and are generated using different clock systems.

14. The stream reproducing device of claim 12 further comprising:
a buffer to temporarily store the time stamped transport stream externally input as a data stream and to provide the time stamped transport stream to the rewriting section, the time stamped transport stream being such that each transport stream packet forming the time stamped transport stream has been added with a time stamp value, some of the transport stream packets contain a PCR value, and the time stamp and PCR values are asynchronous with each other due to different clock systems.

15. The stream reproducing device of claim 14 further comprising:
a PCR detector to detect the PCR value in the time stamped transport stream supplied from the buffer.

16. The stream reproducing device of claim 15 further comprising:
a remaining capacity detector to detect a remaining capacity of the buffer and to cause the oscillation frequency of clock oscillator to vary according to the remaining capacity of the buffer.
